(19) United States
(12) Patent Application Publication
(10) Pub. No.: US 2013/0154273 A1
(43) Pub. Date: Jun. 20, 2013

(54) Engine Generator

(71) Applicant: Katsumi KURIHARA, Aichi (JP)

(72) Inventor: Katsumi KURIHARA, Aichi (JP)

(73) Assignee: ETG Limited, Hong Kong (CN)

(21) Appl. No.: 13/328,662

(22) Filed: Dec. 16, 2011

(51) Int. Cl. H02K 7/18

(52) U.S. Cl. 290/1 A

(57) ABSTRACT

An engine driven generator has an inner rotor type generator with capacitor and AVR (Automatic Voltage Regulator) is selectively connected to a cam shaft, which rotates with half the speed of a crankshaft. An outer rotor type generator with inverter is selectively connected to a flywheel affixed to the crankshaft. Power generated by an engine at adequate rotating speed is fully transmitted to the generator and rotor speed of the generators satisfies requirement. A direction of rotation of crankshaft conforms with the typical standard of the industry relating to engines and generators.

### BACKGROUND OF THE INVENTION

1. Field of the Invention

This invention relates to an engine generator, and more particularly, a construction of engine generator driven by a small four-cycle internal combustion engine.

2. Description of the Related Art

U.S. Pat. No. 7,287,508 to Kurihara and U.S. Pat. No. 7,624,714 to Kurihara et al., which are incorporated herein by reference, disclose a light weight and compact prior art small four-cycle engine construction for portable power tools.

Portable power tools such as line trimmers and blower/vacuums are typical applications of these engines. Engine generators are also suitable to be driven by these engines.

It is common practice to directly couple the driving engine to the generator mounting the engine so that the respective generator shafts are concentric. That is, the crankshaft of engine is connected to a rotor of the generator to generate electromotive force on a stator side of the generator by rotating the rotor.

An important factor for the engine generator is a direction of rotation of power shaft of the engine. The industry has been making effort to reduce cost of products by standardization. As for the direction of rotation of power shaft, for instance, a surface vehicle standard, SAE J824 describes as follows: “Standard Rotation-Counterclockwise rotation as viewed from the principal out put end. If power can be delivered from either end, rotation shall be as viewed from the flywheel end.” It means that a direction of rotation of a main shaft of a generator driven by the engine is to be same as that of the engine.

In U.S. Pat. No. 7,287,508 to Kurihara and U.S. Pat. No. 7,624,714 to Kurihara et al., which are previously referred to, power tools are driven by flywheel and the direction of rotation meets to this standard.

To control voltage generated by the generator, an AVR (Automatic Voltage Regulator) with a capacitor and the like has been widely used. To provide 60 Hz AC power by an AVR type generator, a two-pole generator must be driven at 3600 rpm.

As seen in the emission certification data by the U.S. Environmental Protection Agency issued September 2011, with the recent technical progress of higher speed small engines such as less than 80 cc displacement, it has become possible to operate the engine at a speed equal to or higher than 7200 rpm, thereby obtaining the required horsepower using higher engine speed rather than larger engine displacement.

However, the requirement for a generator operating speed of 3600 rpm, dictated by the number of generator poles, remains unchanged. Hereinafter, it is referred to as “the speed gap problem.”

The U.S. Pat. No. 5,816,102 to Kern proposes a method to solve the speed gap problem. A gear reduction element is provided in the generator. However, since direction of rotation of crankshaft of the engine and main shaft of the generator are reverse to each other due to a gear reduction, the engine or generator becomes out of standardization.

The U.S. Pat. No. 5,606,944 to Kurihara describes an embodiment where a cam shaft, which rotating speed is half of the crankshaft speed, is used to drive a cutter blade of a vegetating machine. However, the implement is limited only to a vegetating machine and direction of rotation or rotating speed of the crankshaft is not specified.

As an another solution of the speed gap problem, an inverter type in which the generated voltage is outputted as alternating current having a required frequency after being converted into direct currency, is becoming dominant. It is an advantage of the inverter type engine generator to have a higher precision of the voltage stability and the frequency characteristic than the AVR type engine generator with capacitor. However, the former is more expensive than the latter.

U.S. Pat. No. 7,004,134 to Higuchi proposes an AVR type generator with an inner rotor and an inverter type generator with an outer rotor, wherein both generators can be mounted on different flywheels in the same engine. However, the speed gap problem can be solved by the inverter type but can not be solved by the AVR type.

Therefore, it is an object of the present invention to provide an engine generator driven by a small four-cycle internal combustion engine which is able to solve the speed gap problem.

It is another object of the present invention to meet the requirement of direction of rotation of the power shaft of an engine to drive generators.

### SUMMARY OF THE INVENTION

In order to achieve the above objects, a cam shaft and a flywheel of a four-cycle, internal combustion engine are used in accordance with types of the generator.

In case of inverter type generator, the generator is driven by a flywheel which is provided at an end of a crankshaft of the engine. Direction of the rotation of the flywheel meets the SAE J824 standard. The rotation speed of crankshaft and rotor of cam shaft can be 7200 rpm and 60 Hz electric power is produced by the inverter.

In case of AVR type generator, the generator is driven by a cam shaft, which is extended to the reverse side of the flywheel and the direction of rotation of the cam shaft is anticlockwise viewed from the end of cam shaft. Since the rotation speed of the cam shaft is half of that of the crankshaft, rotation speed of cam shaft, which is the same as the speed of rotor of generator, is 3600 rpm if crankshaft speed is 7200 rpm. Thus, engine can produce full power and generator can rotate with required speed.

### BRIEF DESCRIPTION OF THE DRAWINGS

FIG. 1 is a cross-sectional side elevation view of the AVR type engine generator taken along the rotating axis of the crankshaft and axis of cylinder bore of the engine.

FIG. 2 is a cross-sectional side elevation view of the inverter type engine generator taken along the rotating axis of the crankshaft and axis of cylinder bore of the engine.

FIG. 3 is an enlarged schematic illustration of the camshaft and the follower mechanism of the engine.

FIG. 4 is a cross-sectional side elevation view of the engine generator of FIG. 1 when the engine is oriented to be upside down.

### BRIEF DESCRIPTION OF THE EMBODIMENTS

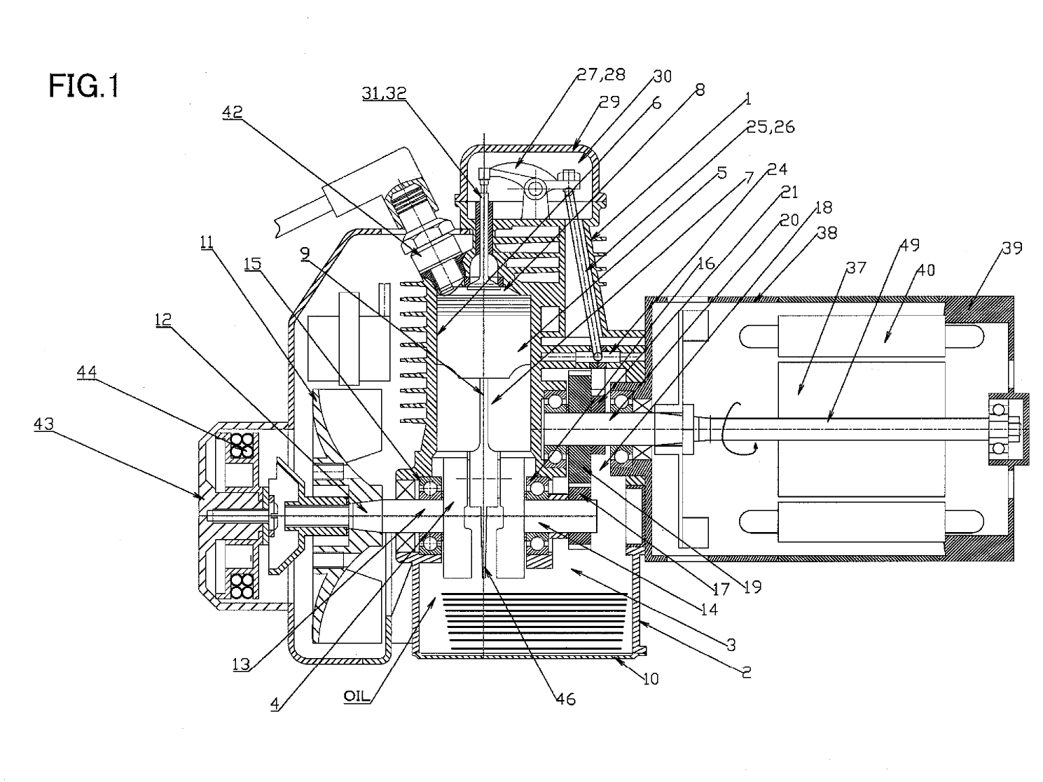

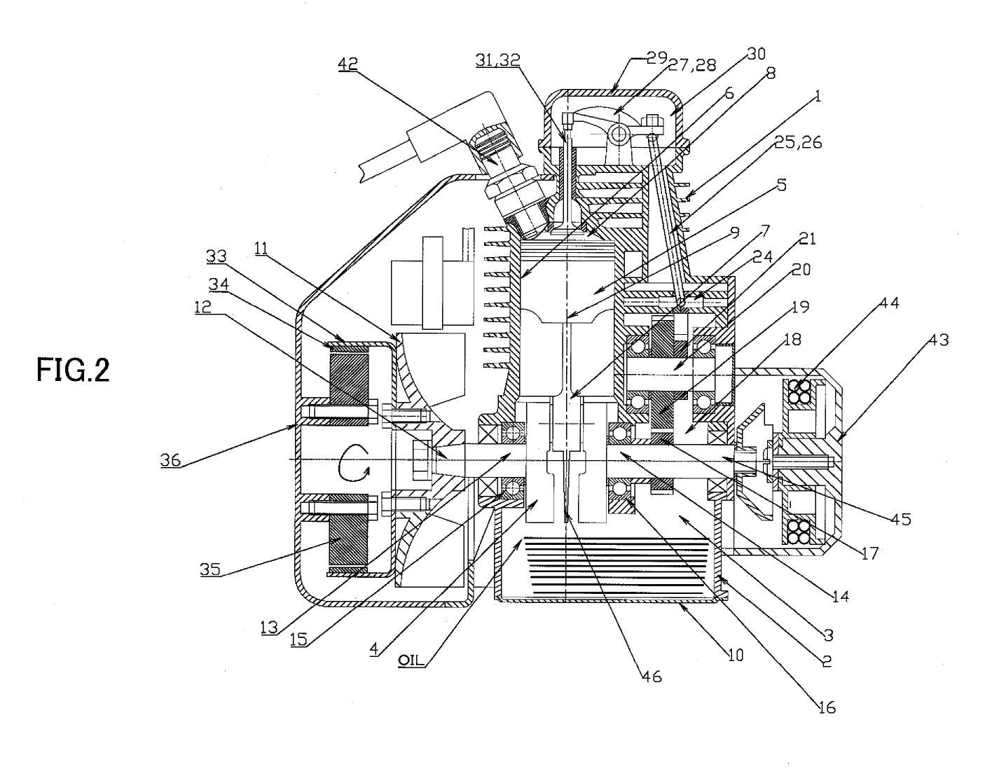

FIGS. 1 and 2 illustrate a cross-sectional side elevation view of a four-cycle engine. The four-cycle engine is made up of a lightweight aluminum housing including a cylinder block 1.

A lower case 2 and said cylinder block 1 mate with each other at the horizontal interface and form a crankshaft chamber 3.

A crankshaft 4 is pivotably mounted within the crankshaft chamber 3 in a conventional manner. The axis of said crankshaft 4 is contained at the horizontal interface to mate cylinder block 1 and lower case 2.

A piston 5 slides within a cylindrical bore 6 and is connected to the crankshaft 4 by a connecting rod 7. A combustion chamber 8 is enclosed in the cylinder block 1.

As illustrated in FIGS. 1 and 2, the cylinder axis 9 of the four-cycle engine is generally upright when in normal use.

The lower case 3 is connected to a bottom cover 10.

A flywheel 11 is provided at a flywheel end 12 of the crankshaft 4.

The axial shafts 13 and 14 of crankshaft 4 are pivotably attached to between the cylinder block 1 and the lower case 2 by a pair of bearings 15 and 16. At the side of bearing 16, a crank gear 17 is mounted on the crankshaft 4 in a cam chamber 18.

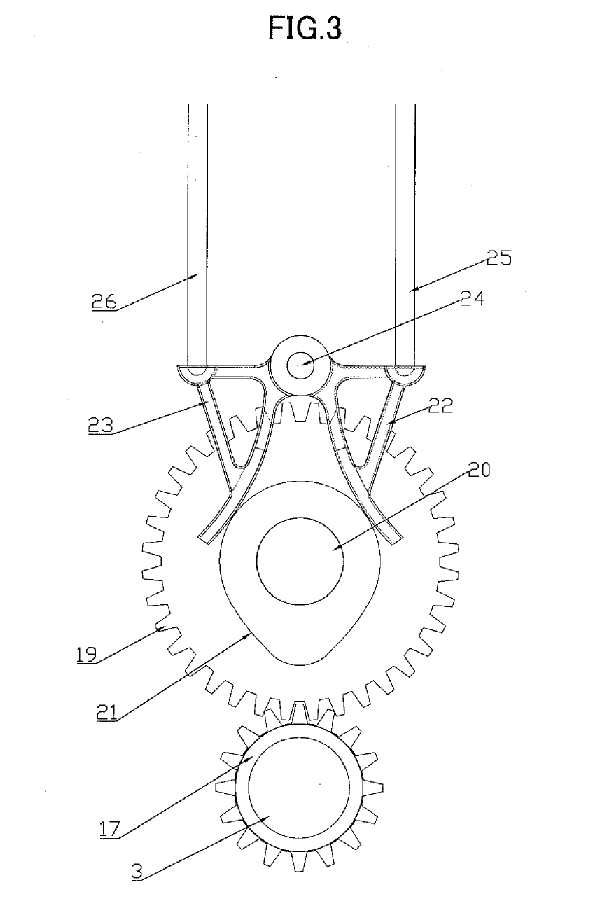

A camshaft drive and valve lifter mechanism is best illustrated in FIGS. 1, 2 and 3. The crank gear 17 mounted on the crankshaft 4 in turn drives a cam gear 19 with twice the number of teeth as the crank gear 17, resulting in the camshaft 20 rotating in one-half the speed that the crankshaft is operated. The cam gear 19 is affixed to a camshaft 20 which is journaled to the cylinder block 1 and includes a rotary cam lobe 21. In the embodiment illustrated, a single cam lobe is utilized for driving both the intake and exhaust valves. Followers 22 and 23 are pivotably connected to the cylinder block 1 by a pivot pin 24.

Affixed to the top of the cylinder block 1 is a valve cover 29 which defines therebetween an enclosed valve chamber 30. Push rods 25 and 26 extend between followers 22 and 23 and rocker arms 27 and 28 located in the valve chamber 30. The rocker arms 27, 28 actuate an inlet valve 31 and an exhaust valve 32 in a conventional manner. The cam 21, push rods 25, 26, rocker arms 27, 28 and inlet and exhaust valves 31, 32 are part of a valve train assembly.

As shown in FIG. 1, a shaft 49 of an inner rotor 37 of an AVR type generator is selectively affixed to the cam shaft 20 to be coaxial with the cam shaft 20.

A generator case 38 is affixed to the engine block 1. The stator 39 is selectively fixed to the inner surface of the generator case 38. Coils 40 are wound around the stator 39. Electro-motive power is generated in said coils 40 by rotating inner rotor 37.

Since the rotating speed of the inner rotor 37 is half of that of the cam shaft 20, the torque generating by engine is transmitted to the inner rotor 37 as twice as the crankshaft torque.

Therefore, the generator speed can be controlled in accordance with a design specification and full power of engine can be transmitted to the generator. For instance, a rated speed of an engine is 7200 rpm and the rotating speed of a AVR type generator is 3600 rpm so that full power of the engine at the rated speed can be transmitted to the generator.

In an embodiment shown in FIG. 2, an outer rotor 33 of an inverter type generator is selectively affixed to the flywheel 11 by bolts. A plurality of magnets 34 are affixed on the inner surface of said outer rotor 33. The stator 35 is fixed to the fan cover 36. A combination of the outer rotor 33 and stator 35 generates electric power and controls frequency of electric power by the inverter. For instance, high engine power at 7200 rpm is transferred to 60 Hz. electric power. Direction of rotation of the outer rotor viewed from flywheel side of the engine is anticlockwise.

As illustrated in FIG. 1, a spark plug 42 is installed in a spark plug hole formed in the upper portion of cylinder block 1.

A re-coil starter 43 having a re-winding rope 43 is provided at a side of flywheel 11 in FIG. 1 and at a side of cam chamber end 45 of the crankshaft 4 in FIG. 2.

An oil scraper 46 is provided on the connecting rod 7. When the engine is started, the oil scraper 46 agitates lubrication oil in the crankshaft chamber 3 and lubricates moving parts of the engine.

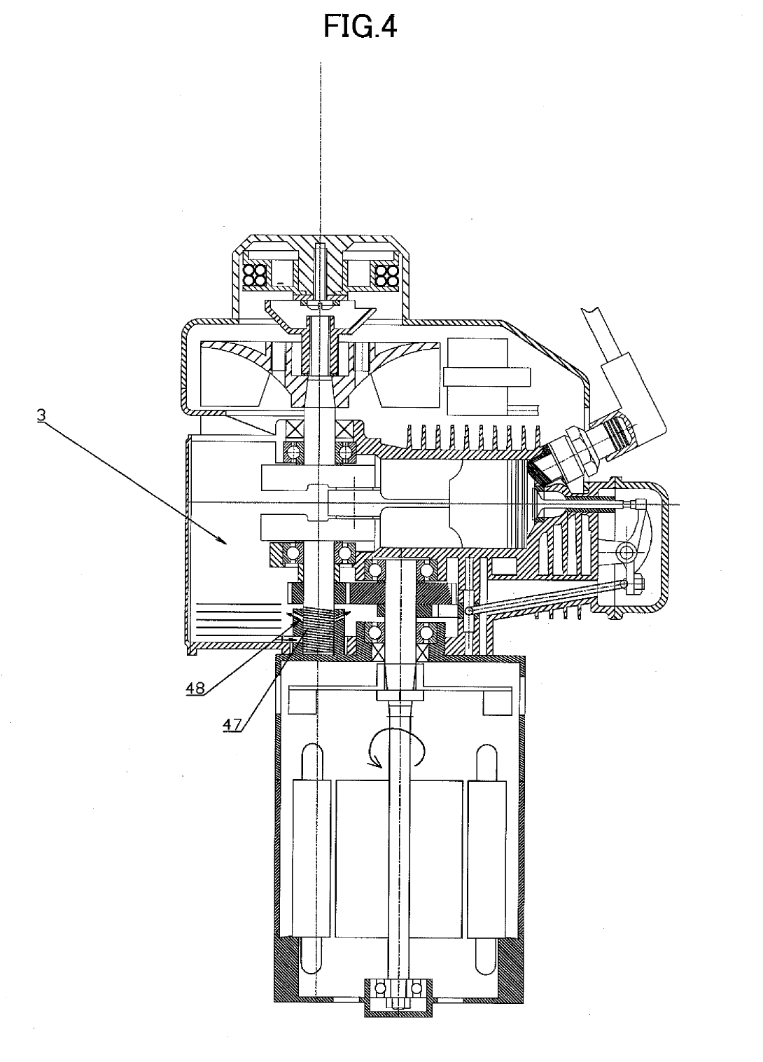

FIG. 4 shows another embodiment of present invention where the crankshaft is postured to be vertical and the generator is placed under the engine.

In the embodiment shown in FIG. 4, the oil scraper shown in FIG. 1 or 2 is removed. Instead, a screw pump 47 is provided at the end of the crankshaft 4. Lubricating oil is inhaled from the crankshaft chamber and pushed out from the holes 48 provided in the boss around the crankshaft 4. Any kinds of pumps other than screw pump are possible to be placed at the end of crankshaft. Since the speed of the crankshaft is high, lubricating oil can be fed sufficiently.

What is claimed is:

1. An engine generator comprising:
a rotor and a stator;
a single-cylinder, four-stroke cycle, spark ignition internal combustion engine having a crankshaft and a cam shaft which rotates with half speed of the crankshaft;
wherein the rotor is selectively affixed to the cam shaft to be rotatable with the cam shaft and the stator is selectively affixed to an inner surface of a generator case affixed to an engine block, said engine generator being driven by said cam shaft.

2. The engine generator set forth in claim 1:
the engine generator further comprising a flywheel driven by said crankshaft and a fan cover at the reverse side of the cam shaft;
wherein the rotor is selectively affixed to the flywheel to be rotatable with the flywheel and the stator is selectively affixed to the fan cover, said generator being selectively driven by said flywheel.

3. The engine generator set forth in claim 1 comprising, an inner rotor type generator having rated rotating speed of 3000 rpm or 3600 rpm.

4. The engine generator set forth in claim 1, wherein a direction of rotation of crankshaft is counterclockwise when viewed from the flywheel side.

5. The engine generator set forth in claim 2, wherein direction of rotation of crankshaft is anticlockwise viewed from the flywheel side.

6. The engine generator set forth in claim 1, wherein displacement of said engine is less than 80 cc.

7. The engine generator set forth in claim 2, wherein displacement of said engine is less than 80 cc.

8. The engine generator set forth in claim 1 comprising engine, wherein a crankshaft is postured vertical and a pump provided at the end of crankshaft inhales lubricating oil and splashes it to the inner parts of the engine.

9. The engine generator set forth in claim 2 comprising engine, wherein a crankshaft is postured vertical and a pump provided at the end of crankshaft inhales lubricating oil and splashes it to the inner parts of the engine.
